(19) United States
(12) Patent Application Publication
(10) Pub. No.: US 2013/0205986 A1
(43) Pub. Date: Aug. 15, 2013

(54) ANNULAR VALVE

(71) Applicants: William Rampen, Midlothian (GB); Uwe Stein, Midlothian (GB)

(72) Inventors: William Rampen, Midlothian (GB); Uwe Stein, Midlothian (GB)

(73) Assignee: MITSUBISHI HEAVY INDUSTRIES, LTD., Tokyo (JP)

(21) Appl. No.: 13/810,563

(22) PCT Filed: Feb. 9, 2012
(86) PCT No.: PCT/JP2012/000867

§ 371 Date: Mar. 18, 2013

(51) Int. Cl. F16K 1/34; F15B 15/00

(52) U.S. Cl. CPC F16K 1/34; F15B 15/00
USPC 91/418; 251/359; 91/471

(57) ABSTRACT

An annular valve (1) has an annular valve member (4) and inner and outer annular valve seats (12, 14). Inner and outer sealing ridges (8, 10) are formed either on the annular valve member or on the valve seats. The inner sealing ridges are more resistant to plastic deformation than the outer sealing ridges. They may be thicker, or made from a harder material. Thus, the annular valve better resists damage arising from greater plastic deformation of the inner sealing ridge than the outer sealing ridge due to greater forces (Fi, Fo) acting on the inner sealing ridge than the outer sealing ridge in use.

### TECHNICAL FIELD

The invention relates to the field of annular valves having a valve member or valve seat with inner and outer sealing ridges (which are usually circular).

### BACKGROUND ART

Known annular valves having inner and outer sealing ridges which differ only in their diameter can have poor operational lifetimes when used in applications where the valve is closed rapidly or subject to a high pressure differential when closed. We have found that when such valves are used in demanding applications, for example hydraulic pumps and motors having cycles of working chamber volume with a relatively high frequency of up to 3000 cycles per minute and working fluid having a pressure of 400 bar, the inner sealing ridge can fail rapidly.

Therefore, the technical problem addressed by the invention is to avoid failure of the inner sealing ridge of known annular valves, to increase the useful lifetime of the annular valves and to provide annular valves useful for demanding applications.

We have discovered that the inner sealing ridge of annular valves fails because the forces acting on the inner sealing ridge during operation are greater than the forces acting on the outer sealing ridge. When the annular valve is then used in an application where relatively high forces are exerted, for example in a hydraulic pump or motor, the inner sealing ridge therefore undergoes greater plastic deformation than the outer sealing ridge during a running-in period of the machine. This leads to torsional stress in the annular valve member and poor sealing by the inner seal. The inner seal then fails relatively quickly, for example as a result of wire drawing or cavitation erosion.

### SUMMARY OF INVENTION

According to a first aspect of the present invention there is provided an annular valve comprising an annular valve member and inner and outer valve seats, the annular valve member having a seat-facing surface which faces the annular valve seats, either the seat-facing surface of the annular valve member or the inner valve seat comprising an annular inner sealing ridge, either the seat-facing surface of the annular valve member or the outer valve seat comprising an annular outer sealing ridge, wherein the inner sealing ridge is more resistant to plastic deformation than the outer sealing ridge.

As the inner sealing ridge is more resistant to plastic deformation than the outer sealing ridge, then plastic deformation of the inner sealing ridge is less than would otherwise be the case, reducing damage to the sealing ridges (for example, from cavitation erosion) and so increasing the lifetime of the annular valve.

It may be that the inner sealing ridge is formed, at least in part, from a material which is harder than the material or materials from which the outer sealing ridge is formed.

Where the inner sealing ridge is formed from a harder material than the outer sealing ridge then, all else being equal, it will deform less (whether axially and/or radially) than the outer sealing ridge under the same stress. Therefore, the effects arising from greater forces being exerted on the inner sealing ridge than the outer sealing ridge will be reduced.

For example, the outer sealing ridge may be formed from the same material as the annular valve member (where the annular valve member comprises the outer sealing ridge) or the outer valve seat (where the outer valve seat comprise the outer sealing ridge) and the inner sealing ridge is formed of a harder material. Thus, the inner sealing ridge may be formed of a harder material than the annular valve member.

It may be that the outer sealing ridge is formed from a softer material than the annular valve member (where the annular valve member comprises the outer sealing ridge) or the outer valve seat (where the outer valve seat comprises the outer sealing ridge).

It may be that the inner sealing ridge is formed, at least in part, from a material which has a higher yield strength than the material or materials from which the outer sealing ridge is formed.

The material from which at least part of the inner sealing ridge is formed may, for example, have at least 1.5 times or at least double the yield strength of the material or materials from which the outer sealing ridge is formed.

Preferably, the inner sealing ridge is thicker than the outer sealing ridge. By thickness we refer to the radial extent of a sealing ridge. Related terms, such as “thicker” should be construed accordingly. By the depth we refer to the axial extent of a sealing ridge.

Where the inner sealing ridge is thicker than the outer sealing ridge then, although a greater force may act on the inner sealing ridge, the force is distributed across the greater contact surface area of the outer sealing ridge, and so the ratio of the axial stress in the inner sealing ridge to the axial stress in the outer sealing ridge is less than the ratio of the axial force exerted by the valve seat on the inner sealing ridge to the axial force exerted by the valve seat on the outer sealing ridge.

Preferably the cross-sectional area of the inner sealing ridge, normal to the axis of the annular valve member, is greater than the cross-sectional area of the outer sealing ridge, normal to the axis of the annular valve member, at an equivalent axial position within the ridges.

The inner and outer ridges may each be circular, however this is not essential. Within this specification and the appended claims, by mean radius we refer to the mean of the radial distance between the axis and the inner or outer ridges, as appropriate. This equates to radius when the inner and outer ridges are circular.

By equivalent axial positions, we refer to positions which are in the same plane if the inner and outer sealing ridges are coplanar (which is typical) but with an axial offset corresponding to any axial offset between the inner and outer sealing ridges (e.g. if the inner and outer valve seats are axially offset).

If the inner and outer sealing ridges have the same thickness, normal to the axis of the annular valve member, the cross-sectional area of the inner sealing ridge will be less than the cross-sectional area of the outer sealing ridge by a ratio equal to the ratio of the circumference of the outer sealing ridge to the circumference of the inner sealing ridge. Thus, it is preferred for the inner sealing ridge to be at least sufficiently thick that the cross-sectional area of the inner sealing ridge, normal to the axis of the annular valve member, exceeds that of the outer sealing ridge, at an equivalent axial position within the ridges.

Typically, the shape of the inner sealing ridge and the outer sealing ridge are selected so that the axial extent of the inner and outer sealing ridges changes by substantially the same amount in use.

It may be that, for at least the majority of the axial extent of the inner and outer sealing ridges, the ratio of the cross-sectional area of the inner sealing ridge perpendicular to the axis of the annular valve member (Ai) to the cross-sectional area of the outer sealing ridge perpendicular to the axis of the annular valve (Ao) is in the range:

$$\frac{Fi}{Fo} - 0.6 ( \frac{Fi}{Fo} - 1 ) to \frac{Fi}{Fo} + 0.6 ( \frac{Fi}{Fo} - 1 )$$

Where Fi is the force exerted on the inner sealing ridge by the inner valve seat (or inner valve member if the inner sealing ridge is formed on the inner valve seat) and Fo is the force exerted on the outer sealing ridge by the outer valve seat (or outer valve member if the outer sealing ridge is formed on the outer valve seat)

The ratio of the force exerted by the valve seat on the inner sealing ridge to the force exerted by the valve seat on the outer sealing ridge, due to a pressure differential across the annular valve member, is a function of the configuration of the annular valve seat and the annular valve member, and the Poisson ratio of the material, or materials, from which the annular valve member is formed. It can be obtained for a given annular valve by calculation, simulation or experiment.

It may be that Ai/Ao is in the range

$$\frac{Fi}{Fo} - 0.25 ( \frac{Fi}{Fo} - 1 ) to \frac{Fi}{Fo} + 0.25 ( \frac{Fi}{Fo} - 1 )$$

or in the range

$$\frac{Fi}{Fo} - 0.1 ( \frac{Fi}{Fo} - 1 ) to \frac{Fi}{Fo} + 0.1 ( \frac{Fi}{Fo} - 1 )$$

or in the range

$$\frac{Fi}{Fo} - 0.05 ( \frac{Fi}{Fo} - 1 ) to \frac{Fi}{Fo} + 0.05 ( \frac{Fi}{Fo} - 1 ) .$$

Preferably, for at least the majority of the axial extent of the inner and outer sealing ridges, Ai/Ao is substantially the same as Fi/Fo.

Nevertheless, as well as forces acting on the inner ridge and outer ridge due to static forces (the pressure differential across the annular valve member, and the biasing spring force), in some embodiments, the ratio of the forces acting on the inner ridge to the outer ridge will be increased by forces arising from the impact of the annular valve member on the valve seats. These forces depend on amongst other things the speed of impact of the annular valve member on the valve seats and the configuration of the annular valve member.

Although it would be possible to design an annular valve in which the forces arising from impact were greatest around the outer periphery of the annular valve, an annular valve member will typically be configured so that the forces arising from impact are greater around the inner periphery of the annular valve. Therefore, in a preferred embodiment, Ai/Ao is greater than Fi/Fo. It may be that Ai/Ao is greater than Fi/Fo×1.1.

It may be that the annular valve member comprises a body and the sealing ridges extend from the body (or the respective valve seat where the valves seats comprises the sealing ridges), wherein said ratios apply at least in an intermediate region of the inner and outer sealing ridges, part way between the body of the annular valve member and the tip of the respective ridge. The relative thickness (and therefore the cross-section) of the inner and outer sealing ridges is less important at the tip of the respective ridges, as the tip is typically relatively narrow and so forms only a relatively small proportion of the bulk of the inner and outer sealing ridges, and at the base end of each sealing ridge where it extends from the body of the annular valve member, as this region is typically broad and so does not deform plastically to the same extent as the remainder of the sealing ridges.

It may be that the inner and outer sealing ridges have a triangular cross-section for at least the majority of their axial extent. The inner and outer sealing ridges may have a triangular cross-section in an intermediate region between the base and tip of each ridge. The surfaces of the triangular regions may extend at angles thetaᵢ and thetaₒ relative to the axis of the annular valve in which case the ratio tan(thetaᵢ)/tan(thetaᵢ) equals the ratio of the thickness of the inner sealing ridge to the thickness of the outer sealing ridge in the triangular regions and this ratio can be selected to be approximately equal to the ratio of the forces which will be applied to the inner and outer sealing ridges during operation.

Typically, the inner and outer sealing ridges taper as they extend axially from the seat-facing surface, wherein the annular valve member has an axis and the inner and outer sealing ridge taper at angles thetaᵢ and thetaₒ relative to the axis, wherein

$$\frac{ri \cdot tan theta i}{ro \cdot tan theta o}$$

is in the range

$$\frac{Fi}{Fo} - 0.6 ( \frac{Fi}{Fo} - 1 ) to \frac{Fi}{Fo} + 0.6 ( \frac{Fi}{Fo} - 1 )$$

It may be that

$$\frac{ri \cdot tan theta i}{ro \cdot tan theta o}$$

is in the range

$$\frac{Fi}{Fo} - 0.25 ( \frac{Fi}{Fo} - 1 ) to \frac{Fi}{Fo} + 0.25 ( \frac{Fi}{Fo} - 1 )$$

or in the range

$$\frac{Fi}{Fo} - 0.1 ( \frac{Fi}{Fo} - 1 ) to \frac{Fi}{Fo} + 0.1 ( \frac{Fi}{Fo} - 1 )$$

or in the range

$$\frac{Fi}{Fo} - 0.05 ( \frac{Fi}{Fo} - 1 ) to \frac{Fi}{Fo} + 0.05 ( \frac{Fi}{Fo} - 1 ) .$$

Nevertheless, as forces arising from the impact of the annular valve on the annular valve seat typically lead to greater forces on the inner sealing ridge than the outer sealing ridge, it may be that

$$\frac{ri \cdot tan theta i}{ro \cdot tan theta o} > \frac{Fi}{Fo}$$

where ri is the mean radius of the inner sealing ridge and ro is the mean radius of the outer sealing ridge.

It may be that the inner and/or outer sealing ridges each have a triangular profile, an ogival profile or an ogee-shaped profile.

It may be that the thickness of the inner and outer sealing ridges is proportional throughout the axial extent of the inner and outer sealing ridges.

It may be that the tips of the inner and outer sealing ridges are in the same plane.

The material from which the inner and outer sealing ridges are formed (in particular the elasticity of the material) may be selected so that the tips of the inner and outer sealing ridges deform elastically by substantially the same amount during operation.

It may be that the annular valve has not been substantially run in. Thus, the properties described above may relate to a newly fabricated valve.

It may be that the annular valve has been run in. Thus, the properties described above may relate to a valve which has been run in.

Running in is the procedure by which a newly formed annular valve is operated and undergoes physical changes until it reaches a substantially constant state for ongoing operation, at which point it is referred to in this specification and the appended claims as ‘run in’. The predominant physical change is plastic deformation of the inner and outer ridges. This is significant in the early stages of running in and then reaches a plateau level of plastic deformation. However there will be other types of wear, for example, removal of some material and its deposition in other places (for example, material might be removed from the ridges and deposited on the seats).

The inner and outer valve seats are typically formed from a harder material than the sealing ridges. In an example, the hardness of the seats, on the Rockwell C Scale is in the range of 45 to 60 and the hardness of the sealing ridges (formed as an integral unit from a homogenous material) are in the range of 23 to 32. Thus, at the end of the running in period the valve seats should typically be unmarked. The inner and outer valve seats may also be formed from a material harder than the annular valve member.

The inner and outer valve seats may be formed from steel. The inner and outer valve seats may be formed from a ceramic material.

The invention also extends in a second aspect to a hydraulic machine comprising at least one working chamber of cyclically varying volume, a fluid line and an annular valve according to the first aspect of the present invention regulating the flow of (working) fluid between the working chamber and the fluid line.

The annular valve may be electronically controlled. For example, the annular valve member may be coupled to an armature. A solenoid in electromagnetic communication with the armature may therefore be employed to actuate the annular valve.

The hydraulic machine may comprise a controller which actively controls the opening and/or closing of the annular valve (and optionally one or more other electronically controlled valve associated with the working chamber) to select the net displacement of working fluid by the electronically controlled valve on each cycle of working chamber volume. The operation of hydraulic machines of this type is known, for example from EP 0361927 and EP 0494236.

The hydraulic machine may be operable a working chamber volume cycle frequency of greater than 1000 cycles per minute or greater than 2000 cycles per minute. The hydraulic machine may be operable with working fluid having a pressure of greater than 100 bar, or greater than 200 bar.

According to a third aspect of the invention there is provided a hydraulic transmission comprising a hydraulic pump, a hydraulic motor, a high pressure fluid line extending from an output side of the hydraulic pump to an input side of the hydraulic motor and a low pressure fluid line extending from an output side of the hydraulic motor to an input side of the hydraulic pump, wherein the hydraulic pump and/or the hydraulic motor are a hydraulic machine according to the second aspect of the invention, wherein the hydraulic transmission comprises a controller which controls the hydraulic pump and the hydraulic motor and regulates the pressure in the high pressure fluid line thereby defining a maximum operating fluid pressure differential between the high pressure fluid line and the low pressure fluid line, wherein, for at least the majority of the axial extent of the inner and outer sealing ridges, the ratio of the cross-sectional area of the inner sealing ridge perpendicular to the axis of the annular valve seat to the cross-sectional area of the outer sealing ridge perpendicular to the axis of the annular valve seat is substantially the same as the ratio of the force exerted on the inner sealing ridge by the annular valve seat to the force exerted on the outer sealing ridge by the annular valve seat when the annular valve is closed under predetermined operating conditions.

The predetermined operating conditions may include a condition that the pressure differential across the annular valve member equals a predetermined pressure differential (which may be the maximum operating fluid pressure different or a mean or median operating fluid pressure differential) The maximum operating fluid pressure differential is typically approximately the same as the maximum pressure difference between the low pressure and high pressure fluid lines during operation at the maximum rated pressure in the high pressure fluid line.

The predetermined operating conditions may include a condition that the cycles of volume of the working chamber for which the annular valve regulated fluid flow have a predetermined frequency. The predetermined conditions may include a predetermined current through a solenoid which actuates the annular valve.

It may be that the shape of the inner sealing ridge and the outer sealing ridge are selected so that the axial extent of the inner and outer sealing ridges changes by substantially the same amount in use in operation of the hydraulic transmission under predetermined operating conditions (i.e. at a predetermined frequency of cycles of working chamber volume and predetermined fluid pressure differential).

According to a fourth aspect of the present invention, there is provided a method of designing an annular valve according to the first aspect of the invention and having an inner sealing ridge which is thicker than the outer sealing ridge, comprising selecting the shape of the inner and outer sealing ridges so that the axial extent of the inner and outer sealing ridges changes substantially constantly under predetermined working conditions.

According to a fifth aspect of the present invention, there is provided a method of running in an annular valve comprising the steps of providing a fluid working machine having a working chamber of cyclically varying volume, a low pressure fluid line, a high pressure fluid line, and an annular valve according to the first aspect of the invention located between the working chamber and either the low pressure fluid line or the high pressure fluid line to thereby regulate the flow of fluid between the working chamber and either the low pressure fluid line or the high pressure fluid line, and operating the fluid working machine with a predetermined frequency of cycles of working chamber volume and predetermined low and high pressure fluid line pressures, wherein the axial extent of the inner and outer sealing ridges deform by substantially the same amount. Preferably the method is continued until plastic deformation of the inner and outer sealing ridges plateaus.

### BRIEF DESCRIPTION OF DRAWINGS

An example embodiment of the invention will now be described with reference to the following Figures in which:

FIG. 1 is a section through key components of a prior art annular valve;

FIG. 2 illustrates deformation which can occur when the annular valve of FIG. 1 is employed;

FIG. 3 shows the practical result of the deformation;

FIG. 4 is a cross section through an annular valve according to the invention;

FIG. 5 is a cross section through an alternative annular valve according to the invention;

FIG. 6 is a cross section through an alternative annular valve according to the invention;

FIG. 7A illustrates an alternative cross-section through sealing ridges;

FIG. 7B illustrates an alternative cross-section through sealing ridges;

FIG. 7C illustrates an alternative cross-section through sealing ridges;

FIG. 7D illustrates an alternative cross-section through sealing ridges;

FIG. 8 illustrates an alternative embodiment in which the inner and outer sealing ridges are formed from different materials;

FIG. 9 illustrates an alternative embodiment in which the inner and outer sealing ridges are formed from different materials; and

FIG. 10 is a schematic diagram showing forces Fi and Fo acting on the inner and outer sealing ridges respectively of the annular valve member arising from the pressure differential P.

### DESCRIPTION OF EMBODIMENTS

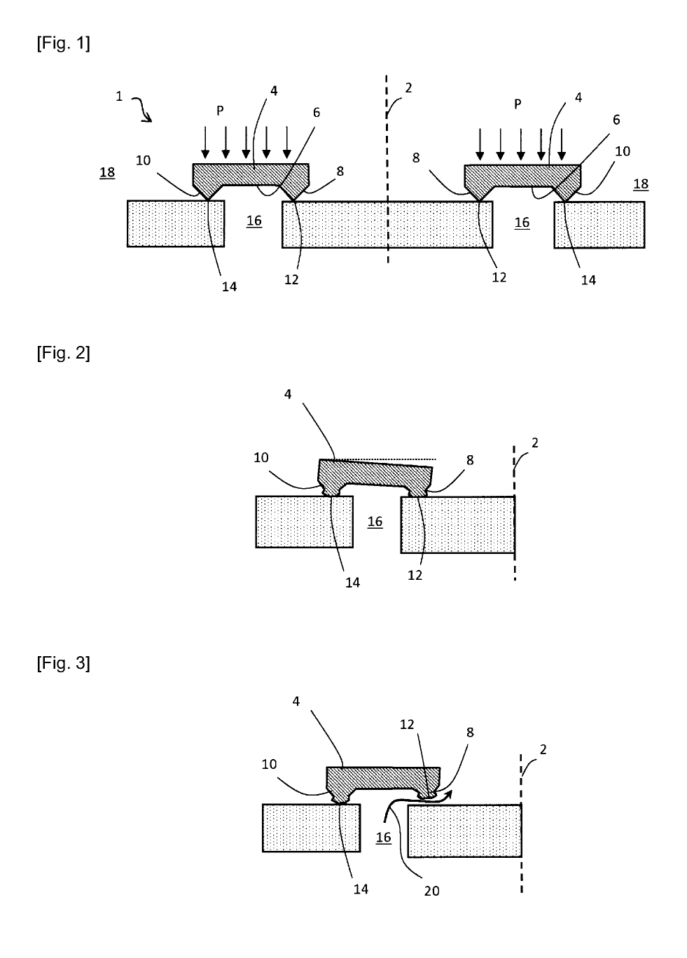

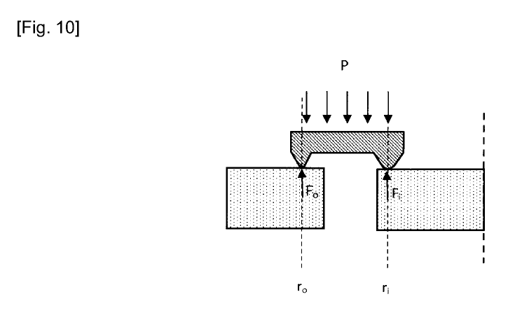

With reference to FIG. 1, a known annular valve 1 is rotationally symmetric about an axis 2. The annular valve has a steel annular valve member 4 having a valve seat facing surface 6 from which inner and outer sealing ridges 8, 10 extend axially towards inner and outer valve seats 12, 14. The annular valve member is movable axially relative to the valve seats to allow or to block the flow of working fluid (e.g. hydraulic fluid, typically oil) between a passage 16 and a gallery 18 extending around the annular valve member and in communication with a manifold (not shown) which may be a high pressure manifold for pressurised fluid (which may, for example, be in a pressure range of 5-1000 bar) or a low pressure manifold which is typically in communication with a working fluid tank and at relatively low pressure (e.g. 1-3 bar). When the annular valve is closed, there will be a pressure differential across the annular valve, leading to a generally even pressure P, illustrated in FIG. 10, across the valve member.

In practice, the force exerted on the inner ridge (Fi, shown in FIG. 10) due to the pressure differential is greater than the force exerted on the outer ridge (Fo). Calculations of the relative forces are discussed below. We have found that, as illustrated in FIG. 2, the inner sealing ridge deforms plastically by a greater amount than the inner ridge under sufficiently demanding conditions. After sufficient use, the inner sealing ridge does not seal at the same time as the outer sealing ridge and pressurised fluid can flow past the inner by flow path 20, illustrated in FIG. 3. This leads to cavitation erosion of the inner sealing ridge.

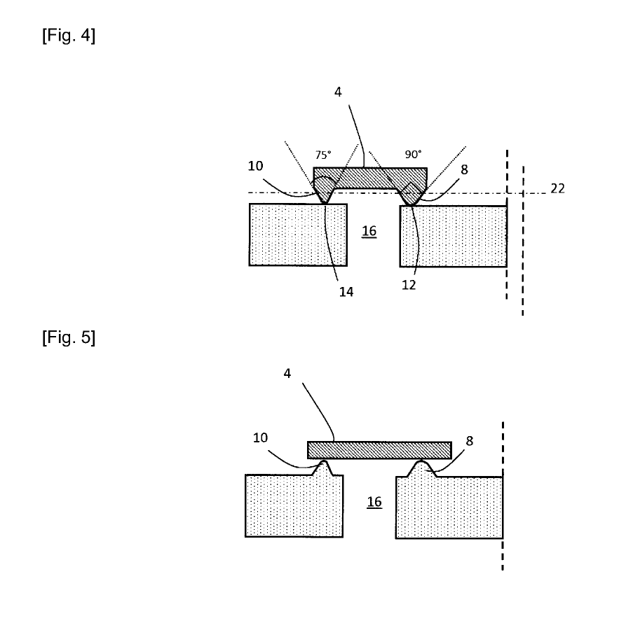

FIG. 4 is a cross-section through an annular valve member according to the invention. The inner sealing ridge is thicker than the outer sealing ridge. It has a greater dimension in cross-section through a plane 22 which is orthogonal to the axis. As a result, although the force acting on the inner sealing ridge is greater than the outer sealing ridge, the resulting stress is balanced. Therefore, where the inner and outer sealing ridge are made from corresponding materials, they deform plastically to the same extent, and therefore maintain the same axial extent when the annular valve is first used (run in).

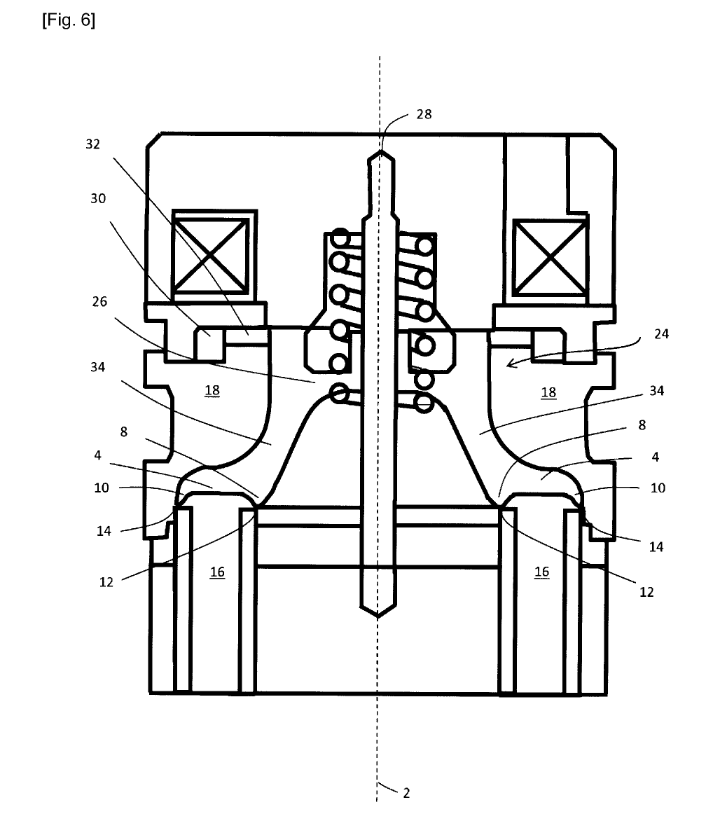

FIG. 5 illustrates an alternative embodiment in which the annular valve member takes the form of a disc and the inner and outer sealing ridges are formed on the inner and outer valve seats, instead of the annular valve member. Again, the inner sealing ridge is thicker than the outer sealing ridge.

FIG. 6 is a cross-section through a more detailed embodiment of a solenoid operated annular valve (functioning as an example of an electronically controlled annular valve). The annular valve has a moving portion 24 formed from a stem 26, which is guided by a guide member 28. The stem is integral with an armature 30 having a plurality of apertures 32 through which working fluid can flow to avoid unnecessary resistance to movement of the annular valve member. From the stem, a plurality of radially distributed arms 34 extend radially outwards and axially to support the annular valve member 4 which has inner and outer sealing ridges 8, 10. The inner sealing ridge is thicker than the outer sealing ridge in a plane orthogonal to the axis 2, as before. The inner and outer sealing ridges seat on inner and outer valve seats 12, 14 and the annular valve thereby dividing a gallery 18 which is in communication with a manifold from passages 16 which extend to a working chamber (e.g. a piston cylinder).

One skilled in the art can determine the correct relative thickness for the inner and outer sealing ridges taking into account the configuration of the annular valve member and annular valve seat either by calculation or by experiment.

In order to determine the correct relative thickness by experiment, annular valves formed with inner and outer sealing ridges having different relative thickness can be fabricated and run in using a fluid working machine having consistent operating conditions, e.g. a consistent frequency of cycles of working chamber volume and consistent pressures in the high and low pressure manifolds. It is most important during this process to regulate the pressure of the manifold which is in fluid communication with the annular valve, which may be either the low pressure manifold or the high pressure manifold depending on the intended purpose of the annular valve. These operating conditions should be consistent between experiments but may vary during experiments provided that they do so in a fashion which is generally consistent from one experiment to the next. The experiment should be run for each annular valve until changes in the shape of the inner and outer sealing ridges due to plastic deformation plateau. The inner and outer sealing ridges can then be inspected using mechanical or optical profile measuring techniques to determine which annular valve member has inner and outer sealing ridges of most consistent depth after the running in period.

In order to determine the correct relative thickness by calculation, it is necessary to take into account both static forces which will be exerted on the inner and outer valve seats during operation in particular conditions (e.g. with a specific pressure differential across the annular valve member, a particular frequency of cycles of working chamber volume, a particular impact speed of the annular valve member on the annular valve seats etc.) and also impact forces.

Static forces on the inner and outer sealing ridge arising from the pressure difference P acting on the annular valve members can be calculated by, for example, finite element modeling or from first principles, taking into account the configuration of the annular valve. Where the annular valve is, or resembles, a planar disc, a suitable formula is provided by Roark's Formulas for Stress and Strain (Young, W. C.; Roark, R. J. and Budynas, R. G., 7^{th} edition, 2002, publisher McGraw-Hill), the contents of which are incorporated herein by virtue of this reference.

According to Roark's Formulas for flat circular plates of constant thickness, with inner and outer edges simply supported, pp. 457, 458, 464, Qa, Qb (unit shear force (i.e. force per unit of circumferential length) at the outer edge and inner edge respectively) can be calculated as follows, where the vertical deflection of the plate (yₐ, y_{b})=0 and where radial and tangential bending moments (M_{rb}=0 and Mᵣₐ=0) can be assumed to be zero:

$$\begin{matrix}{θ}_{b} = \frac{{qa}^{3}}{D} \frac{{C}_{3} {L}_{17}}{{C}_{1} {C}_{9}} \frac{{C}_{2} {L}_{11}}{{C}_{3} {C}_{2}} & {Q}_{b} = qa \frac{{C}_{1} {L}_{17} - {C}_{2} {L}_{12}}{{C}_{1} {C}_{9} - {C}_{3} {C}_{7}} \\ {θ}_{a} = {θ}_{b} {C}_{4} + {Q}_{b} \frac{{a}^{2}}{D} {C}_{6} \frac{{qa}^{3}}{D} {L}_{14} & {Q}_{a} = {Q}_{b} \frac{b}{a} - \frac{q}{2 a} ( {a}^{2} - {r}_{a}^{2} )\end{matrix}$$

$$where$$

$$C 1 = \frac{1 + v}{2} \cdot \frac{b}{a} \cdot ln ( \frac{a}{b} ) + ( \frac{1 - v}{4} ) \cdot ( \frac{a}{b} - \frac{b}{a} )$$

$$C 3 = \frac{b}{4 \cdot a} ( ( {( \frac{b}{a} )}^{2} + 1 ) \cdot ln ( \frac{a}{b} ) + {( \frac{b}{a} )}^{2} - 1 )$$

$$C 7 = \frac{1}{2} \cdot ( 1 - {v}^{2} ) \cdot ( \frac{a}{b} - \frac{b}{a} )$$

$$C 9 = \frac{b}{a} \cdot ( \frac{1 + v}{2} \cdot ln ( \frac{a}{b} ) + \frac{( 1 - v )}{4} \cdot ( 1 - {( \frac{b}{a} )}^{2} ) )$$

$$L 11 = \frac{1}{64} \cdot ( 1 + 4 \cdot {( \frac{ro}{a} )}^{2} - 5 \cdot {( \frac{ro}{a} )}^{4} - 4 \cdot {( \frac{ro}{a} )}^{2} \cdot ( 2 + {( \frac{ro}{a} )}^{2} ) \cdot ln ( \frac{a}{ro} ) )$$

$$\begin{matrix}L 17 = \frac{1}{4} 1 \frac{1 v}{4} 1 \frac{{ro}^{4}}{a} \frac{{ro}^{2}}{a} & 1 + ( 1 + v ) ln \frac{a}{ro} \\ Qb = q \cdot a \cdot ( \frac{C 1 \cdot L 17 - C 7 \cdot L 11}{C 1 \cdot C 9 - C 3 \cdot C 7} ) & Qinner = Qb \cdot b \cdot 2 \cdot π\end{matrix}$$

Where thetaₐ, theta_{b} are the externally applied changes in radial slope (in radians), v is Poisson's ratio and q is the applied load per unit area (arising from the pressure differential, P).

Assuming that;

The pressure P=400 bar=q, the diameter of the inner sealing ridge=21 mm (so the radius, ri=10.5 mm), the diameter of the outer sealing ridge=31 mm (so the radius, ro=15.5 mm), the material has Poisson's ratio, v=0.3

Gives;

C1=0.3113; C3=0.0046; C7=0.3634; C9=0.2356;

L11=38747 10⁻⁴; and

L17=0.0427

Therefore,

$$Qb = 1.1362 \cdot {10}^{5} mPa ( or N / m )$$

$$Qinner = 7495.9497 N$$

$$Lfactinner = \frac{Qinner}{b \cdot 2 \cdot π} ; Lfactinner = 1.1362 \cdot {10}^{5} mPa ( or N / m )$$

$$At = ( {a}^{2} - {b}^{2} ) \cdot π ; At = 408.407 {mm}^{2} ; A = a \cdot At$$

$$Q = 16336.2818 N$$

$$Qouter = Q - Qinner ; Qouter = 8840.3321 N$$

$$Lfactouter = \frac{Qouter}{a \cdot 2 \cdot π}$$

$$Lfactouter = 90773.0677 mPa$$

$$Loadratio = \frac{Lfactinner}{Lfactouter} = 1.2517$$

Thus, for the parameters set out above, the predicted ratio of the force on the inner ridge (referred to herein and in the claims as Fi) to the force on the outer ridge (referred to herein and in the claims as Fo) is 1.2517 and, if this were the only relevant consideration, one would predict that the correct ratio of the thickness of the inner ridge to the thickness of the outer ridge is 1.2517.

In practice, forces also arise from the impact of the annular valve member on the valve seat. For an annular valve as shown in FIG. 6 having a moving portion including a central stem and axially and radially extending arms supporting the inner edge of the annular valve member, it is apparent that on impact, forces sufficient to rapidly decelerate the mass of the entire moving portion (including the armature) will be transmitted through the inner sealing ridge. Thus, the mass of the moving portion is coupled rigidly to the inner sealing ridge. However, corresponding forces through the outer sealing ridge will be lower as the arms do not extend directly to the outer sealing ridge and there will be slight flexion within the arms and annular valve member and so the outer sealing ridge is less rigidly coupled to the moving portion. Such forces can be calculated by finite element modeling or measured in a test rig.

One skilled in the art would approach calculation of impact related forces by finite element modeling, using programs such as Ansys (available from Ansys, Inc. of Canonsburg, Pa., USA), CosmosWorks (available from H Feddersen, Rosenheim, Germany), or Adams (available from MSC.Software Corporation, Santa Ana, Calif., USA), in particular exploring the impact speed, fluid flow around the valve, different frequencies and elasticities, and the elastic coupling of masses to the inner and outer sealing ridges. In the embodiment shown in FIG. 6 it would therefore be preferable for the ratio of the thickness of the inner ridge to be greater than the ratio of force acting on the inner ridge to force acting on the outer ridge due to static forces (1.2517 in the example above). Thus, the preferred ratio of the thickness of inner ridge to the outer ridge might be 1.3-1.4.

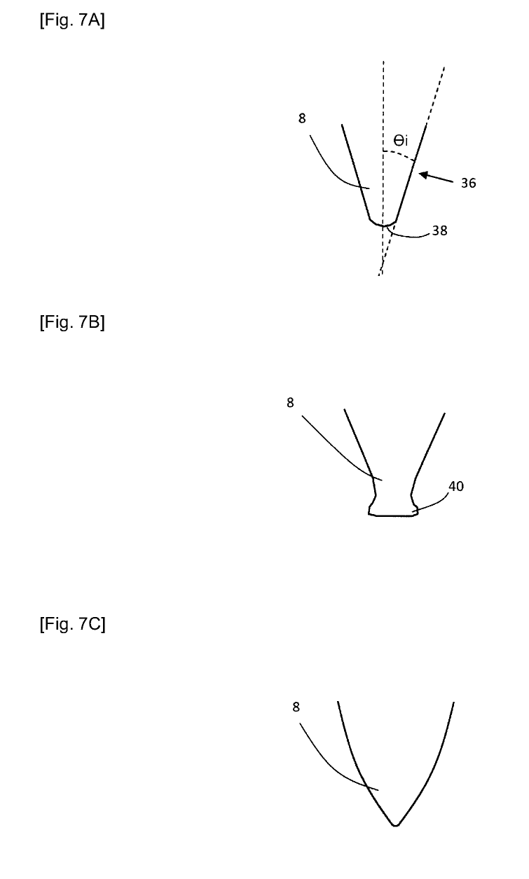

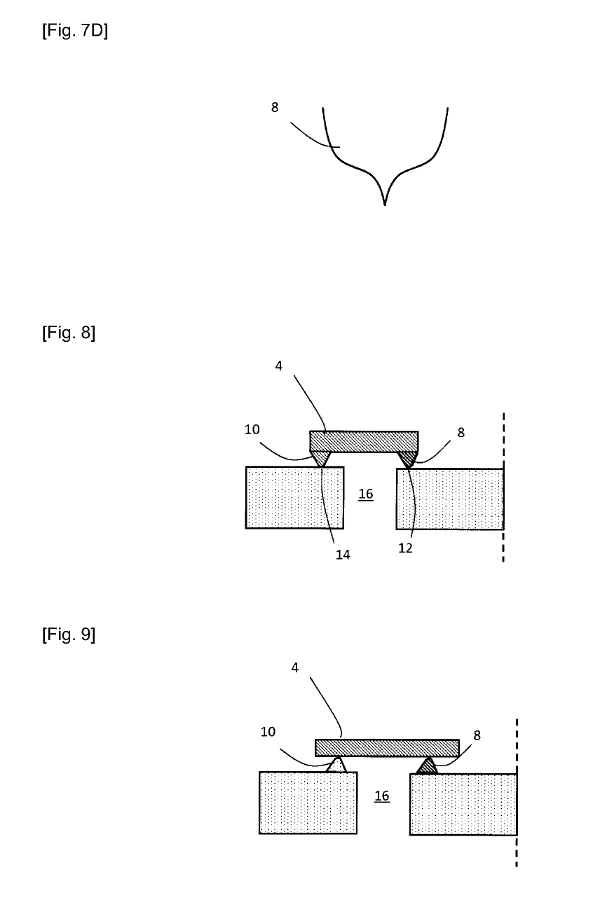

FIGS. 7A through 7D illustrate examples of possible shapes of the inner and outer sealing ridges. In the embodiment of FIG. 7A, the inner sealing ridge is triangular in an intermediate region 36 but has a radiused tip 38. Although the sealing ridges may adopt such a conformation when they are first formed, after operation they may adopt the shape shown in FIG. 7B where there is a thicker portion 40 at the tip, due to plastic deformation. FIGS. 7C and 7D show examples of sealing ridges having ogival and ogee-shaped cross-sections. In each case, the cross-section through the outer and inner sealing ridges would differ only in that the inner sealing ridge would be proportionately thicker throughout the axial extent of the inner and outer sealing ridges.

It is also possible to cause the inner sealing ridge to deform correspondingly with the outer sealing ridge whilst still having the same cross-section as the outer sealing ridge by making the inner sealing ridge from a harder material. With reference to FIG. 8, the annular valve member and the inner sealing ridge are formed integrally from the same material (e.g. same grade of steel) and the outer sealing ridge is formed from a softer material (e.g. a softer grade of steel). Alternatively, the outer sealing ridge might be made from the same material as the annular valve member with the inner sealing ridge formed from a harder material than the annular valve member, or the inner and outer sealing ridges could both be formed from different materials to the annular valve member, provided that the inner sealing ridge is formed from a harder material than the outer sealing ridge. With reference to FIG. 9, the same principle can be applied when the inner and outer sealing ridges are part of the valve seats. In this case, the inner sealing ridge may be formed from the same material as the valve seats and the outer sealing ridge may be formed from a softer material. The outer sealing ridge may be formed from the same material as the valve seats and the inner sealing ridge may be formed from a harder material. Both the inner and outer sealing ridges may be formed from different materials to the valve seats, where the inner sealing ridge is formed from a harder material to the outer sealing ridge. It may be that the inner sealing ridge and the inner valve seat are formed together from a first material and the outer sealing ridge and the outer valve seat are formed together from a second material, where the first material is harder than the second material.

Further variations and modifications may be made within the scope of the invention herein disclosed.

### REFERENCE SIGNS LIST

1 Annular valve

2 Axis

4 Annular valve member

6 Valve seat facing surface

8 Inner sealing ridge

10 Outer sealing ridge

12 Inner valve seat

14 Outer valve seat

16 Passage

18 Gallery

20 Flow path

22 Plane orthogonal to axis

24 Moving port

26 Stem

28 Guide member

30 Armature

32 Aperture

34 Arm

36 Intermediate region

38 Radiused tip

40 Thicker portion

P Pressure exerted on annular valve member

Fi Force acting on inner sealing ridge

Fo Force acting on outer sealing ridge

1. An annular valve comprising an annular valve member and inner and outer valve seats, the annular valve member having a seat-facing surface which faces the annular valve seats, either the seat-facing surface of the annular valve member or the inner valve seat comprising an annular inner sealing ridge, either the seat-facing surface of the annular valve member or the outer valve seat comprising an annular outer sealing ridge, wherein the inner sealing ridge is more resistant to plastic deformation than the outer sealing ridge.

2. An annular valve according to claim 1, wherein the inner sealing ridge is formed, at least in part, from a material which is harder than the material or materials from which the outer sealing ridge is formed.

3. An annular valve according to claim 1, wherein the inner sealing ridge is formed, at least in part, from a material which has a higher yield strength than the material or materials from which the outer sealing ridge is formed.

4. An annular valve according to claim 1, wherein the inner sealing ridge is thicker than the outer sealing ridge.

5. An annular valve according to claim 4, wherein the cross-sectional area of the inner sealing ridge, normal to the axis of the annular valve member, is greater than the cross-sectional area of the outer sealing ridge, normal to the axis of the annular valve member, at an equivalent axial position within the ridges.

6. An annular valve according to claim 3, wherein, for at least the majority of the axial extent of the inner and outer sealing ridges, the ratio of the cross-sectional area of the inner sealing ridge perpendicular to the axis of the annular valve member (Ai) to the cross-sectional area of the outer sealing ridge perpendicular to the axis of the annular valve (Ao) is in the range:
$$\frac{Fi}{Fo} - 0.6 ( \frac{Fi}{Fo} - 1 ) to \frac{Fi}{Fo} + 0.6 ( \frac{Fi}{Fo} - 1 )$$
Where Fi is the force exerted on the inner sealing ridge by the inner valve seat (or inner valve member if the inner sealing ridge is formed on the inner valve seat) and Fo is the force exerted on the outer sealing ridge by the outer valve seat (or outer valve member if the outer sealing ridge is formed on the outer valve seat)

7. An annular valve according to claim 6, wherein for at least the majority of the axial extent of the inner and outer sealing ridges, Ai/Ao is substantially the same as, or greater than, Fi/Fo.

8. An annular valve according to claim 3, wherein the inner and outer sealing ridges taper as they extend axially from the seat-facing surface, wherein the annular valve member has an axis and the inner and outer sealing ridge taper at angles thetaᵢ and thetaₒ relative to the axis, wherein
$$\frac{ri \cdot tan theta i}{ro \cdot tan theta o}$$
is in the range
$$\frac{Fi}{Fo} - 0.6 ( \frac{Fi}{Fo} - 1 ) to \frac{Fi}{Fo} + 0.6 ( \frac{Fi}{Fo} - 1 )$$

9. An annular valve according to claim 3, wherein
$$\frac{ri \cdot tan theta i}{ro \cdot tan theta o} > \frac{Fi}{Fo} ,$$
wherein ri is the mean radius of the inner sealing ridge and ro is the mean radius of the outer sealing ridge.

10. An annular valve according to claim 1, wherein the inner and/or outer sealing ridges each have a triangular profile, an ogival profile or an ogee-shaped profile.

11. An annular valve according to claim 10, wherein the thickness of the inner and outer sealing ridges is proportional throughout the axial extent of the inner and outer sealing ridges.

12. An annular valve according to claim 1, wherein the tips of the inner and outer sealing ridges are in the same plane.

13. An annular valve according to claim 1, wherein the elasticity of the inner and outer sealing ridges are selected so that the tips of the inner and outer sealing ridges deform elastically by substantially the same amount during operation.

14. An annular valve according to claim 1, wherein the annular valve has not been substantially run in.

15. An annular valve according to claim 1, wherein the annular valve has been run in.

16. A hydraulic machine comprising at least one working chamber of cyclically varying volume, a fluid line and an annular valve according to claim 1 regulating the flow of fluid between the working chamber and the fluid line.

17. A hydraulic transmission comprising a hydraulic pump, a hydraulic motor, a high pressure fluid line extending from an output side of the hydraulic pump to an input side of the hydraulic motor and a low pressure fluid line extending from an output side of the hydraulic motor to an input side of the hydraulic pump, wherein the hydraulic pump and/or the hydraulic motor are a hydraulic machine according to claim 16, wherein the hydraulic transmission comprises a controller which controls the hydraulic pump and the hydraulic motor and regulates the pressure in the high pressure fluid line thereby defining a maximum operating fluid pressure differential between the high pressure fluid line and the low pressure fluid line, wherein, for at least the majority of the axial extent of the inner and outer sealing ridges, the ratio of the cross-sectional area of the inner sealing ridge perpendicular to the axis of the annular valve seat to the cross-sectional area of the outer sealing ridge perpendicular to the axis of the annular valve seat is substantially the same as the ratio of the force exerted on the inner sealing ridge by the annular valve seat to the force exerted on the outer sealing ridge by the annular valve seat when the annular valve is closed under predetermined operating conditions.

18. A method of running in an annular valve comprising the steps of providing a fluid working machine having a working chamber of cyclically varying volume, a low pressure fluid line, a high pressure fluid line, and an annular valve according to the first aspect of the invention located between the working chamber and either the low pressure fluid line or the high pressure fluid line to thereby regulate the flow of fluid between the working chamber and either the low pressure fluid line or the high pressure fluid line, and operating the fluid working machine with a predetermined frequency of cycles of working chamber volume and predetermined low and high pressure fluid line pressures, wherein the axial extent of the inner and outer sealing ridges deform by substantially the same amount.
